(19) United States
(12) Patent Application Publication
(10) Pub. No.: US 2013/0052323 A1
(43) Pub. Date: Feb. 28, 2013

(54) Low Fat Bakery Product

(71) Applicant: The University of Birmingham, West Midlands (GB)

(72) Inventors: Ian Timothy Norton, Northamptonshire (GB); Jennifer Elizabeth Norton, West Midlands (GB)

(73) Assignee: The University of Birmingham, West Midlands (GB)

(21) Appl. No.: 13/660,241

(22) Filed: Oct. 25, 2012

Related U.S. Application Data
(63) Continuation-in-part of application No. PCT/GB2011/050642, filed on Mar. 29, 2011.

(30) Foreign Application Priority Data
Apr. 26, 2010 (GB) 1006910.2

(51) Int. Cl. A23D 7/00; A23L 1/0532; A21D 13/08; A23L 1/0524; A23D 7/005; A21D 13/00; A23L 1/05; A23L 1/0562

(52) U.S. Cl. 426/556; 426/602; 426/603; 426/573; 426/575; 426/576; 426/577; 426/549; 426/417; 426/442

(57) ABSTRACT

The invention provides a comestible product, such as bread, cake, pastry, biscuit or cookie, comprising a water-in-oil emulsion, the water-in-oil emulsion comprising bakery fat continuous phase and an aqueous phase dispersed substantially throughout the bakery fat continuous phase. The bakery fat is typically selected from butter, margarine, animal fat and vegetable shortening.

### CROSS REFERENCE TO RELATED APPLICATION

The present invention is a continuation-in-part application of International Application No. PCT/GB2011/050642, filed Mar. 29, 2011, which claims priority to Application No. GB 1006910.2, filed Apr. 26, 2010, each of which is incorporated herein by reference in its entirety.

### FIELD OF THE INVENTION

The present invention relates to bakery fats comprising water-in-oil emulsions, bakery products containing such emulsions and methods of producing such emulsions and products.

Particularly in the West, obesity is a major cause for concern. Health conscious consumers are increasingly looking for products that have low fat and calorific content. However, they are often not prepared to accept healthier alternatives that have poor (or even different) taste and/or texture to the traditional products. Thus, food manufacturers face the problem of making low fat alternatives to some of the consumers' favourite products that not only taste as good but that also give the same texture and sensation in the mouth when eaten. Fat plays an important role in giving products their distinctive texture as well as taste. Although in some products fat can be removed and/or substituted to produce a healthier product it is proving difficult with bakery fats to produce products that are acceptable to the consumer. Moreover, many consumers are not prepared to pay a premium for a low fat alternative, it therefore being important that any new products can be manufactured in a cost effective manner.

Many baked products use shortenings such as butter, margarine, and vegetable shortening. Shortenings coat the flour grains, reducing their contact with the moisture in the recipe, and shortening the length of the gluten strands when the flour is stirred with that moisture, hence they are called “shortenings”. In traditional baking, where solid fats are creamed with crystalline sugar, tiny air cells are whipped into the batter, so the baked good will have a fine, aerated texture. When a shortener, or fat, is removed or reduced, it increases the chances that the end product will be tough and full of tunnels

The production of low fat bakery products has presented particular problems. The rules for low-fat baking are completely different from those for traditional full-fat baking. Reduced- and low-fat batters are more sensitive to overmixing, overbaking, ingredient substitutions, improper measuring, oven temperatures, and choice of baking pans. The problem is that any water added to the fat phase to reduce calories prior to this invention has been found to hydrate the starch and protein present and cause extensive structuring and poor quality products. Attempts at low fat products have always leaked water when in use and given problems with texture and flavour. This has limited their use and severely restricted the amount of water that can be included.

The Inventors have found that it is possible to incorporate water into the shortenings by encapsulating the water droplets with stable fat crystal shells.

Fat crystal shells around water droplets provide a solution to the problems associated with including water to reduce the fat and/or calorie content of bakery fats and products containing these fats. Although we do not want to be bound by theory, it has been found that by constructing an intact crystalline shell, which osmotically separates the water phase (inside the bakery fat) and the starch/protein for the duration of the mixing process and for the initial stages of baking, the problem is overcome.

Existing products are very hard (i.e. stick type margarines) so processing routes need to allow the very hard fats to form shells via a process to position them at the fat water interface, but by making shells that are insensitive to overworking in the process (destruction of the emulsion due to shear). As the shells are sintered they will resist water loss on mixing with flour etc and not impact upon the product quality.

By using the method of the invention, bakery fats with water content up to 75% can be produced. To achieve water contents of this level it is preferable to include hydrocolloids in the aqueous phase. This allows the phase inversion process to be carried out and gives stability to the product, particularly in the mixing stage with flour (i.e. resistance to breakage), and will slow down water release in the baking process, thereby reducing any negative impact of the low fat use on final product properties.

Accordingly, a first aspect of the invention provides a comestible product comprising a water-in-oil emulsion, the water-in-oil emulsion comprising a bakery fat continuous phase and an aqueous phase dispersed substantially throughout the bakery fat continuous phase.

In a further aspect of the invention the aqueous phase preferably contains a hydrocolloid. Incorporating the hydrocolloid increases the resistance of the water phase to the deformation that the bakery fat is subjected to during the manufacture of comestible products.

A further aspect to the invention provides a method of making a comestible product, comprising mixing together bakery fat with an aqueous phase, such as a hydrocolloid-containing aqueous phase to produce a water-in-oil emulsion.

The bakery fat can be a shortening such as those used in bakery margarines, other fats such as butter, vegetable shortening or lard may also be used. Such fats may contain a fraction (over 80%) mainly composed of mono- or poly-unsaturated triglycerides and a fraction (less than 40%) of hardened fat containing mainly saturated triglycerides such as tripalmitin.

Comestible products are products fit to be eaten as food. That is, they are edible products, such substances being suitable for use as food and that may be eaten, drunk or otherwise taken into the body.

The comestible product may be a bakery product. It may be a bread, cake, pastry, biscuit or cookie.

Emulsions are mixtures of two or more immiscible liquids. One liquid (in this case the aqueous phase), is dispersed in the other (the continuous phase) which in the currently claimed invention is a bakery fat or shortening.

Existing bakery fats and shortenings are very hard, for example stick type margarines, so processing routes need to allow the very hard fats to form shells via a process to position them at the fat water interface, but by making shells that are insensitive to overworking in the process (destruction of the emulsion due to shear). As the shells are sintered they will resist water loss on mixing with flour etc and not impact upon the product quality.

The addition of a hydrocolloid to the water increases the resistance to deformation of the water droplets so the water-in-oil emulsion remains stable without “leakage” of the water.

Hydrocolloids in foods are generally known in the art. These include for example agar, sodium alginate, carrageenan and pectin or a mixture of any two or more of these hydrocolloids. The hydrocolloid may be gelatine or a mixture of gelatin with other hydrocolloid systems. Gelatine may be produced by hydrolysis of proteins of bovine, fish or porcine origin. The gelatine utilised may be porcine, preferably the gelatin shall be high gel strength grade (250 g bloom).

The fat preferably contains an emulsifier. The emulsifier is typically a glyceride such as mono, di or triglyceride, comprising, for example a monoglyceride. Typically the glyceride is a mixture of saturated and unsaturated monoglyceride such as Hymono 4404 or a soya bean lecithin such as Bolec Z. The emulsifier may also be a mixture of, for example monoglyceride and diglyceride, such as at least 45% monoglyceride or at least 70% or at least 90% monoglyceride may also be used. These are believed to cause the triglycerides in the bakery fat to coat the water droplet surface. The fatty acids attached to the glycerides may be C16 to C22 saturated or unsaturated fatty acids, including for example, palmitate or oleate.

The aqueous phase may comprise 90%-100% (preferably 95%-99.5%) by weight water and 0%-10% (preferably 0.5%-5%) by weight of hydrocolloid.

The fat phase may comprise 95%-99.9% (preferably 98%-99.5%) by weight of fat and 0.1%-5% (preferably 0.5%-2%) by weight emulsifier.

The water-in-oil emulsion may comprise:

(i) 10%-90%, preferably 20%-80%, preferably 40%-70% fat; and
(ii) 10%-90%, preferably 20%-80% preferably 30%-60% aqueous phase, wherein the percentages are the weight percentage of the total weight of (i), and (ii).

Comestible products may additionally comprise within the water-in-oil emulsion, one or more additional components selected from sugar, sweeteners, flavourings, salt and/or colourings. Such components may be incorporated into one or more of the bakery fat, aqueous phase before mixing or the mixture of the bakery fat and aqueous phase.

Such components are generally known in the making of bakery products.

Sugars may be mono-, di- and/or poly-saccharides. These include glucose, fructose, sucrose, lactose, maltose, trehalose, cellobiose or maltodextrins. Sweeteners include saccharine and aspartame. Flavourings include, for example, vanilla essence.

Such additional components are generally known in the art.

The bakery fat emulsion is typically mixed with combinations of the following ingredients as required for the final product, including but not limited to: flour (such as wheat flour though other edible flours such as maize, rice, potato, almond or rye flours or mixtures thereof may be used), sugar, sweeteners, water, milk, milk powder, yeast, eggs, salt, and optional product specific ingredients such as colourings, flavourings, fruit, nuts, chocolate, cocoa powder.

Typically the bakery fat emulsion is 5%-70% of the bakery product, more typically 5%-10% by weight for bread products, 20%-40%% by weight of cake products and 20%-70% by weight of biscuit or cookie products.

To produce the comestible product, bakery fat such as a bakery margarine may be heated (optionally with an emulsifier) and mixed with heated aqueous phase (optionally with a hydrocolloid) to produce a heated mixture. Typically the bakery fat and aqueous phases are heated to a temperature in the range 60° C. to 70° C. before mixing. Typically the fat phase is heated to a temperature in the range 60° C. to 70° C. to melt all of the solids content. Typically the fat and aqueous phases are then pre-mixed by adding the aqueous phase to the fat phase in a pre-mix tank with a paddle stirrer with the pre-mix tank maintained at a temperature in the range 60° C. to 70° C.

The pre-mix may then be pumped through, for example, a margarine line to form the water-in-oil emulsion. Margarine lines are generally known in the art. They typically comprise a scrape surface heat exchanger (referred to as the “A unit” or SSHE) and a pin stirrer (see FIG. 1).

The heated mixture may be allowed to cool to a controlled temperature to allow fat crystals to form shells around the water particles. This may be, for example, in the scrape surface heat exchanger. This is typically at approximately 15 to 26° C. or 16° C., 20° C., 24° C. or 35° C. for typically 1 to 15 or typically 10 minutes.

The cooled mixture may then be allowed to warm to a temperature close to the melting temperature of the fat crystals that form the shell to allow the crystals to sinter together to form a substantially intact crystal shell. Typically, the temperature is raised to within 2° C. to 10° C. below the crystal melting temperature. For example, the temperature may be raised to between 25° C. and 34° C., for example 26° C. to 33° C. This may be for longer than the time spent at the cooler temperature (in for example the SSHE), for example 5 to 20 minutes.

The temperature at this stage may also be cycled, for example by dropping the temperature, for example by approximately 2° C. and then optionally raising it again to improve fat shell formation. This may be achieved by passing through a second pin stirrer set at a lower temperature.

The pin stirrer is typically maintained at a temperature close to the melting temperature of the fat crystals that form the shell, for example the triglycerides, to allow the crystals to sinter together to form an intact crystal shell. The sintering can be enhanced by a slight temperature cycle in the order of 2° C. at a temperature within 5° C. to 10° C. below the crystal melting temperature.

For example, the scrape surface heat exchanger may be kept at approximately 15° C. to allow the fat phase to cool and the pin stirrer kept at 25° C.

It is believed that emulsifiers, such as monoglycerides crystallise first, seeding the further crystallisation of the fats in the mixture. The raising of the temperature to just below the crystal melting temperature appears to allow imperfect or partially crystallised shells to melt and reform, thereby improving the formulation of the crystal shell around the water particles.

If the temperature for forming the crystal shells is too high then the crystals melt and are no longer present at the interface with the water droplet and the shell properties are lost resulting in an unstable water-in-oil emulsion.

If the temperature for formation of the fat crystals is too low then the solubility of the crystals in the oil phase is too low so sintering occurs very slowly or is stopped altogether resulting in a reduced stability for the water-in-oil emulsion.

The water particles or droplets in the emulsion are typically less than 25 μm diameter and preferably in the size range 5 μm to 15 μm

The water particles are encapsulated in a fat crystal shell. The fat crystal shells can be monoglyceride, diglyceride or triglyceride, typically comprising monoglyceride and are preferably annealed to give substantially defect free shells. The presence of such fat shells can be detected by, for example monitoring the melting curves of the emulsion.

The product according to the invention is a reduced-fat product. The presence of water reduces the amount of fat present in the bakery fat.

The invention will now be described by way of example only with reference to the following figures:

### BRIEF DESCRIPTION OF THE DRAWING

FIG. 1 is a schematic diagram of the process for producing the water-in-oil bakery fat emulsion.

### DETAILED DESCRIPTION OF THE INVENTION

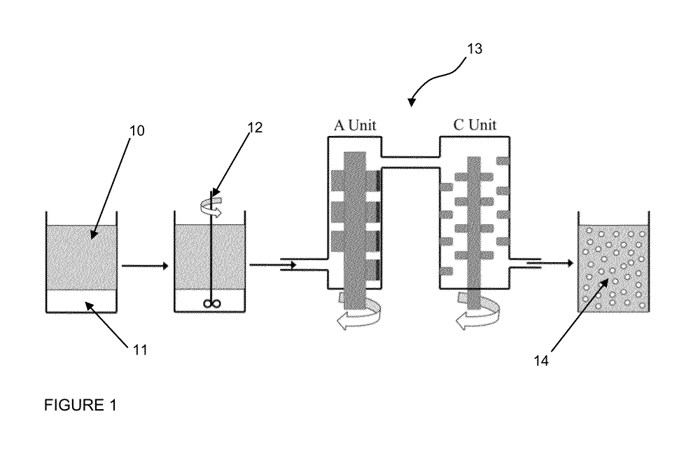

FIG. 1 shows a schematic diagram of the equipment used to produce the water-in-oil bakery fat emulsion. Bakery margarine is heated to 60° C. and a saturated monoglyceride is added as an emulsifier. Water is heated to 60° C. and a hydrocolloid is added and stirred until dissolved. The bakery margarine/emulsifier and water/hydrocolloid are then mixed to produce a coarse pre-mix in a pre-mix tank using a paddle stirrer, the tank being maintained at 60° C. This pre-emulsion mixture is then pumped through the margarine line 13.

The margarine line 13 comprises a scrape surface heat exchanger (A Unit) and pin stirrer (C Unit). The margarine line is a continuous process in which the temperature of the two jackets can be manipulated so that sintering can occur during the emulsification stage through the control of shear and temperature.

The scrape surface heat exchanger was kept at 15 degrees C., which allowed the bakery fat emulsion to cool to approximately 20 degrees C., to form fat crystals. The pin stirrer is kept at 25 degrees C. to anneal the fat crystal shells to ensure they are defect free. Both the scrape surface heat exchanger and pin stirrer are fitted with water baths (not shown) so the temperature can be altered to optimise the fat crystal shell structure of the fat phase surrounding the water droplets and the stability of the resulting bakery fat emulsion.

The emulsion could also be prepared using an additional A unit and C unit to give an ACAC processing route. Alternatively other equipment known in this field could be used providing it can deliver the temperature requirements as these are critical in producing shells of the necessary structure and properties.

The resulting water-in-oil bakery fat emulsion 14 then has the further ingredients added for the production of the required bakery product. The bakery product can be a bread, cake, pastry, biscuit or cookie. These further ingredients are added by a suitable mixing process known within the bakery industry for the required product and can include but are not limited to flour, sugar, sweeteners, water, milk, milk powder, yeast, eggs, salt.

In certain varieties of bakery products additional ingredients might be required, such as colourings, flavourings, fruit, nuts, chocolate, cocoa powder. The sweeteners and flavourings can be added to the aqueous phase and/or the bakery fat emulsion and/or the bakery product mixture.

The bakery product mixture is then cut and/or formed to the required shapes before cooking, after which it is removed from any bakeware, processed further if required by, for example filling and decorating before wrapping for storage and retail distribution.

The use of the aqueous phase that is added to the bakery fat to form the water-in-oil bakery fat emulsion gives a bakery product with a reduced fat content that has a stable shelf life that is not degraded by release of the water content caused by the shear forces exerted during mixing processes.

The use of the hydrocolloid in the aqueous phase gives increased stability to the emulsion with increased resistance to release of water from the emulsion during mixing and aids in the process so that fat continuous products are produced.

The water-in-oil emulsion decreases the content of saturated fatty acids in the final product as a consequence of replacing some of the fat content with water giving additional health benefits.

Although we do not want to be bound by theory the invention is thought to successfully provide for the replacement of a proportion of the fat with water by osmotically separating the water from the flour during the mixing of the product ingredients. The release of the water is delayed until the baking stage when it can provide benefits in maintaining a moist texture in the final product.

A range of water-in-oil bakery fat emulsion compositions as described in the following examples have been made that have been suitable for incorporation into the mixing process for making a bakery product.

### Example 1

Bakery margarine containing 60% fat phase and 40% aqueous phase.

The fat phase had solids content of 50% at 10° C., 30% at 20° C., 18% at 25° C. 10% at 30° C. 4.5% at 35° C. and 0% at 40° C.

The aqueous phase contained 1% Gelatin (grade 250 bloom). The aqueous phase was made up by adding gelatin to water at 60° C. with stirring until dissolved. The fat phase was heated to 60° C. and 1% saturated monoglyceride (monopalmatin) was added.

A course premix was made by adding the water to the fat phase in a pre-mix tank with a paddle stirrer. The tank was maintained at 60° C.

The low fat bakery margarine was manufactured by passing through a scraped surface heat exchanger (A unit) followed by a pin stirrer. The outlet temperatures were controlled to be 15° C. for the A unit and 25° C. for the pin stirrer. A range of temperatures could be used:

A unit between 10° C. and 20° C.

Pin Stirrer between 20° C. and 30° C.

After exiting the pin stirrer, samples were collected and air cooled to 5° C. in a refrigerator until required for mixing to make a bakery product.

The monoglyceride is used as the emulsifier and to crystallise at the interface resulting in a shell structure. This then seeds crystallisation of the triglyceride in the fat phase, resulting in an intact shell surrounding the droplet.

The shaft speed in the A unit and pin stirrer were selected to produce shell droplets (shaft speeds of 500-1500 rpm were found to be appropriate). Droplet sizes of between 2 and 15 um were possible.

The small droplet sizes were found to be ideal in order to keep the water partitioned in the fat during subsequent mixing into bread, cake, biscuit and cookie dough.

### Example 2

As example 1 but with 1% NaCl in the aqueous phase.

### Example 3

As example 1 but no gelatin in aqueous phase.

### Example 4

As example 1 but with 50% fat phase and 50% aqueous phase. Care needs to be taken to keep the premix as fat continuous. Slow addition with gentle stirring were found to be ideal.

### Example 5

### Shortening

Example 2 was repeated but with a fat phase with sold content of: 55% at 10° C., 44% at 20° C., 38% at 25° C., 30% at 30° C., 18% at 35° C., 8% at 40° C. and 0% at 45° C.

### Example 6

Example 2 was repeated with 40% fat and 60% aqueous phase.

In this example the pre-mix was water continuous and a phase inversion process was carried out. This was achieved crystallising within the A unit as before and then by using a shaft speed of ˜1000 rpm in the pin stirrer (i.e. by using the pin stirrer as the invertor). Droplet sizes of <5 um were obtained.

### Example 7

Example 6 was repeated but instead of using gelatin, 0.5% iota carrageenan was used

### Example 8

Example 7 was repeated in which the iota carrageenan was replaced by kappa carrageenan.

### Example 9

Example 6 was repeated in which the carrageen was replaced by 0.4% sodium alginate.

### Example 10

Example 7 was repeated but using the fat phase described in Example 5

### Example 11

Example 2 was repeated with 25% fat phase and 75% aqueous phase. The process described in Example 6 was used.

### Example 12

Example 2 was repeated but Hymono 4404 was used in place of monopalmatin. In this example the shells are made from the triglycerides (long chain length, saturated) present in the fat phase.

### Example 13

Example 2 was repeated but Bolec Z was used in place of monopalmatin. In this example the shells are made as explained in Example 12.

### Further Examples

Pre-emulsification with an overhead mixer at 80° C., addition of the aqueous phase into the molten fat phase, both phases being at temperature.

Emulsification+crystallisation in a A and C unit (Scraped surface heat exchanger and pin stirrer).

Scraper of the A unit and pin stirrer of the C unit set at max rotation speed (approx. 1350 RPM).

### Example 14

With Radiamuls MG 2910
(E 471, supplier: Oleon, saturated mono-and diglyceride,
>90% monoglyceride, melting point 63-69° C. - supplier data)
1-2% emulsifier
40% water
Cargill shortening: P100
Flow rate: 40 ml/min

| | | |
|---|---|---|
| A unit | jacket temperature: 25° C. | exit temperature: 25° C. |
| C unit | jacket temperature: 33° C. | exit temperature: 33° C. |

Final droplet size: 10-15 μm

Flow rate: 110 ml/min

| | | |
|---|---|---|
| A unit | jacket temperature: 16° C. | exit temperature: 26° C. |
| C unit | jacket temperature: 26° C. | exit temperature: 26° C. |

Final droplet size: 15-20 μm
Note:
similar results were obtained with Cargill's SUGIN 471 PH 40 Flakes

### Example 15

With Radiamuls MG 2610 (E 471, supplier: Oleon, unsaturated mono-and
diglyceride 45% monoglyceride, melting point 25° C. - supplier data)
2% emulsifier
40% water
Cargill shortening: P100

| | | |
|---|---|---|
| A unit | jacket temperature: 23° C. | exit temperature: 23° C. |
| C unit | jacket temperature: 28° C. | exit temperature: 28° C. |

No further addition of High melting fat

| | |
|---|---|
| Flow rate: | 30 to 50 ml/min |
| Final droplet size: | <5 μm (water only as the aqueous phase) |
| | 5-10 μm |
| | (aqueous phase containing 5% gelatine 80 bloom) |
| | 10 μm |
| | (aqueous phase containing 5% gelatine 250 bloom) |

Addition of 2% double fractionated palm oil (from Cargill)

| | |
|---|---|
| Flow rate: | 40 ml/min |
| Final droplet size: | 5 μm |

Addition of 2% hydrogenated cottonseed oil (from Cargill)

| | |
|---|---|
| Flow rate: | 60 ml/min |
| Final droplet size: | 10 μm |

Note:
similar results were obtained with Cargill's SUGIN 471 J 40 AO

### Example 16

2% emulsifier
60% water
Cargill shortening: P100

| | | |
|---|---|---|
| A unit | jacket temperature: 23° C. | exit temperature: 23° C. |
| C unit | jacket temperature: 28° C. | exit temperature: 28° C. |

| | |
|---|---|
| Flow rate: | 30 to 50 ml/min |
| Final droplet size: | <10 μm (water only as the aqueous phase) |
| | 10-15 μm |
| | (aqueous phase containing 5% gelatine 80 bloom) |

1. A comestible product comprising a water-in-oil emulsion, the water-in-oil emulsion comprising bakery fat continuous phase and an aqueous phase dispersed substantially throughout the bakery fat continuous phase.

2. A comestible product according to claim 1, wherein the bakery fat is selected from butter, margarine, animal fat and vegetable shortening.

3. A comestible product according to claim 1, wherein the aqueous phase comprises a hydrocolloid.

4. A comestible product according to claim 1, wherein the product comprises a hydrocolloid which is selected from agar, sodium alginate, carrageenan, gelatine and pectin, or mixtures thereof.

5. A comestible product according to claim 1, wherein the aqueous phase comprises 90%-100% of water and 0% to 10% by weight of hydrocolloid.

6. A comestible product according to claim 1, wherein a fat phase comprises an emulsifier.

7. A comestible product according to claim 1, wherein the fat phase comprising 95% to 99.9% by weight of fat and 0.1%-5% by weight of emulsifier.

8. A comestible product according to claim 1, wherein the oil-in-water emulsion comprises 10% to 90% weight percent fat and 10% to 90% by weight of aqueous phase.

9. A comestible product according to claim 1, wherein the aqueous phase is present in particles or droplets of less than 25 μm diameter.

10. A comestible product according to claim 1, which is a bread, cake, pastry, biscuit or cookie.

11. A comestible product according to claim 1, which is a bakery product comprising 5% to 70% by weight of water-in-oil emulsion.

12. A comestible product according to claim 1, comprising water particles forming the aqueous phase, the water particles substantially surrounded by fat crystal shells.

13. A method of making a comestible product comprising mixing bakery fat with an aqueous phase to produce a water-in-oil emulsion.

14. A method according to claim 13, wherein the aqueous phase comprises a hydrocolloid.

15. A method according to claim 13, comprising a hydrocolloid selected from agar, sodium alginate, carrageenan, gelatine and pectin.

16. A method according to claim 13, wherein the bakery fat comprises an emulsifier.

17. A method according to claim 13 comprising mixing 10% to 90% by weight of bakery fat with 10% to 90% by weight of aqueous phase.

18. A method according to claim 13 comprising mixing the water-in-oil ingredient with one or more other ingredients to produce a bakery product comprising 5% to 70% by weight of water-in-oil emulsion.

19. A method according to claim 13 comprising:
(i) heating the mixture of bakery fat and aqueous phase to produce the water-in-oil emulsion; and
(ii) cooling the heated mixture to a predetermined temperature to allow fat crystals to form shells substantially around water particles forming the aqueous phase.

20. A method according to claim 19, comprising the step of:
(iii) heating the mixture from the predetermined temperature to a temperature below the melting temperature of the fat crystals.
